(19) United States
(12) Patent Application Publication
(10) Pub. No.: US 2010/0069158 A1
(43) Pub. Date: Mar. 18, 2010

(54) GAME SYSTEM AND METHOD IN COMBINATION WITH MOBILE PHONES AND A GAME CONSOLE

(75) Inventor: Do-Sung Kim, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ARUON GAMES INC., Seoul (KR)

(21) Appl. No.: 12/522,911

(22) PCT Filed: Feb. 8, 2007
(86) PCT No.: PCT/KR2007/000690

§ 371 Date: Jul. 10, 2009

(30) Foreign Application Priority Data
Jan. 13, 2007 (KR) 10-2007-0004025

(51) Int. Cl. A63F 13/12

(52) U.S. Cl. 463/42

(57) ABSTRACT

A game system and method for enabling a mobile phone to interact with a user game console is disclosed. The game system enables a mobile phone and a user game console to interact with a game server, enables the user game console to interact with a video display, displays video data generated from the user game console on the video display in order to allow a user or gamer to play a desired game on a large screen, and allows a plurality of gamers to play the game using a single user game console over wireless communication for use of mobile phones. The game system can display different information on not only a common screen for all the game participants but also at least one screen for each gamer only, such that a plurality of gamers can participate in the game at the same time on a single screen image, resulting in the implementation of the simultaneous-participation games

### TECHNICAL FIELD

The present invention relates to a game system in combination with a mobile phone and a game console (hereinafter referred to as a user game console), and a method for controlling the same, and more particularly to a game system for enabling a mobile phone and a user game console to interact with a game server, enabling the user game console to interact with a video display (also called an image display), displaying video data generated from the user game console on the video display in order to allow a user or gamer to play a desired game on a large screen, and allowing a plurality of gamers to play the game using a single user game console over wireless communication for use of mobile phones, and a method for controlling the game system.

### BACKGROUND ART

As well known in the art, with the increasing development of information communication technologies, many developers have increasingly conducted intensive research into information provision technology capable of transmitting real-time information of various fields to a plurality of subscribers via at least one host server over a data communication network such as the Internet.

Based on the above-mentioned information provision technology, not only peripheral techniques (e.g., cache-memory expansion technology) for quickly providing the subscriber with correct information, but also information selection technology and information compression technology have been recently developed to conveniently appeal to interests or preferences of the subscriber, such that a variety of contents required for the information selection technology and the information compression technology and solutions for the contents are being intensively researched by many developers.

Particularly, a variety of online games have been recently introduced to the market, such that many users participate in the online games. A game system is largely classified into an online game and a single-play game. In the case of the single-play game, the single-play game does not access a plurality of users at the same time to progress the game, and a specific story is pre-programmed in a game machine, such that a routine corresponding to the specific story is executed according to an event signal of the user. In the case of the online game, several users simultaneously gain access to a corresponding server on the condition that basic game contents are prestored in the server, such that the online game can be executed.

Therefore, since a variety of garners having different levels gain access to the server at the same time in order to play the online game, a user cannot predict reactions and game levels of other users who participate in the online game, such that the users have much interest in the online game as compared to the single-play game, resulting in the increasing number of users who prefer the online game to the single-play game.

However, most online games invite their garners, who desire to participate in their games, to access a game-content provision server via a single user game console, such that the single user game console displays the same information. As a result, the above-mentioned online games allow only a single garner from among several garners to participate in simultaneous-participation-type games (e.g., a Korean “Hwatu” card game, a card game, a mah-jong play, and a horse race, etc.), such that a large number of garners have difficulty in playing the game at the same time.

Several joysticks or mice are required even when all members of the family can simultaneously play an online game based on a network, a plurality of garners or users play a desired game by exchanging a single controller with each other, lines of the joysticks or mice become tangled, such that the lines of the joysticks or mice have become more and more complicated, the corresponding game makes slow progress, and the power of garner attention to the game is deteriorated.

### DISCLOSURE OF INVENTION

### Technical Problem

Therefore, the present invention has been made in view of the above problems, and it is an object of the present invention to provide a game system for enabling a mobile phone and a user game console to interact with a game server, enabling the user game console to interact with a video display, displaying video data generated from the user game console on the video display to provide the user with a common screen image or common information, and displaying unique screen image or information of each user serving as a participant on the screen of the mobile phone, and allowing a plurality of users or garners to enjoy playing the game, and a method for controlling the game system.

### Technical Solution

In accordance with one aspect of the present invention, the above and other objects can be accomplished by the provision of a game system for enabling a mobile phone to interact with a user game console comprising: a game provision server (GPS) for transmitting a plurality of game contents to a plurality of user game consoles (C1˜Cn), establishing game-participants information received from the user game consoles (C1˜Cn), and performs information registration of the game participants, performs a game operation function, performing arithmetic processing of corresponding game contents upon receiving game-execution key signals and gamer information from the user game consoles (C1˜Cn), transmitting modified game video- and audio-data to the user game consoles (C1˜Cn), receiving a game key signal from the mobile phone of each gamer, and performing arithmetic processing using the received game key signal, thereby conducting a corresponding game; and multi-user game consoles (B1˜Bn), each of which interfaces with the game provision server (GPS), transmits game authentication information to the game provision server (GPS), transmits a game participation setup signal of each gamer to the game provision server (GPS), receives game video- and audio-data from the game provision server (GPS), outputs the received game video- and audio-data, transmits a game event signal of each gamer to the game provision server (GPS), and controls the game system upon receipt of a game operation value of the game provision server (GPS).

Preferably, the multi-user game console includes: a user game console for transmitting gamer authentication information and a game participation setup signal of each gamer to the game provision server (GPS), receiving game images, advertising images, and audio data from the game provision server (GPS), transmitting a game event signal of the gamer to the game provision server (GPS), receiving a game operation value of the game provision server (GPS), and outputting the received game operation value to a video display; a video display for outputting the game images and the audio data received from the user game console; and at least one mobile phones for interacting with the user game console, and transmitting the gamer authentication information, the game participation setup signal of each gamer, and the game key signal for playing a corresponding game to the game provision server (GPS).

Preferably, the mobile phone interact with the user game console according to characteristics of game contents, such that it partially displays game data received from the game provision server (GPS) on only the screen of the mobile phone.

Preferably, the mobile phone includes: a G-sensor for automatically generating a key signal equal to a key input signal according to the movement of the mobile phone, whereby input data is automatically transmitted to the game provision server (GPS) over a wireless communication network for the mobile phone.

Preferably, the mobile phone includes a game-execution algorithm for executing the game, such that the game-execution algorithm enables the mobile phone to recognize the occurrence of key data in the case of the game execution, enables the mobile phone to automatically access a communication network, and enables the mobile phone to automatically transmit the key data to the game provision server (GPS) pre-registered.

Preferably, the mobile phone includes: a transmission/reception unit for enabling the mobile phone to communicate with the user game console via a Bluetooth, IR (Infrared) communication, or other RF (Radio Frequency) data communication, such that the game data is transmitted to the game provision server (GPS) over the Internet.

Preferably, the game provision server (GPS) includes: a wireless communication module which includes a Web server, a fire wall, a protocol setup processor, communicates with the mobile phone or the user game console, receives authentication/user setup signals and key signals associated with various games, and transmits game operation data to the mobile phone or the user game console, resulting in the implementation of data transmission/reception; a user setup processor which receives a request signal for participating in the game from the mobile phone or the user game console, and establishes a corresponding request signal, gamer information, and a mobile phone number; a game-content management processor which processes a variety of game-content data and modification data in association with the user game console (C1˜Cn), and manages the processed resultant data; advertisement-data output control processor which transmits advertisement data to the mobile phone or the user game console in combination with the output of game data; a user game console/mobile phone interaction register which registers information of at least one of the mobile phones, capable of conducting the game via any one of user game consoles (C1˜Cn), in combination with a Web ID of a corresponding user, and manages a game key signal and a game operation value according to each user game console and each mobile phone; a game data operation processor which processes operation of game data to be transmitted to the user game console by the key data received from the mobile phone; a settlement processor which settles a usage fee of the game-contents or item purchase costs by means of the authentication process of the mobile phone or the user game console; a memory which includes a RAM and ROM, and stores data-data processing information, game-participant's information, interaction information between the mobile phone and the user game console, settlement authentication data, and advertisement data; and a controller which establishes the game-participant setup process in combination with the mobile phone of the user game console, and performs a game output control function, an advertisement-data output control function, a settlement process interface function using the operation value of the modified game data, performs operation of game data using key data received from the mobile phone, transmits the game operation value to the user game console using the key data received from the mobile phone, and controls overall operations of the game system.

In accordance with another aspect of the present invention, there is provided a game method for enabling a mobile phone to interact with a user game console comprising the steps of: a) receiving, by a game provision server (GPS), a game initialization selection signal from a user game console; b) transmitting, by the user game console, mobile phone information, Web ID information, authentication information, a participant's game start request signal to the game provision server (GPS); c) receiving, by the game provision server (GPS), a corresponding signal, registering the Web ID information in combination with the mobile phone, transmitting corresponding game-content data to the user game console, and authenticating the beginning of a game; d) receiving, by the user game console, the corresponding game-content start information and game-content information, and outputting the received information to a video display; e) if the game participant moves the mobile phone to another location, or generates a game event signal by pressing a specific key, transmitting the corresponding event signal to the game provision server (GPS) via a mobile-phone transmission/reception unit connected to either a mobile-phone communication network or the user game console; f) performing arithmetic processing of game data according to the event signal of a corresponding gamer, and transmitting modified game data to the corresponding user game console and the mobile phone; and g) displaying the modified game data on the screen of the video display.

Preferably, the step c) includes the steps of: c1) receiving, by the game provision server (GPS), gamer's authentication data; c2) determining whether a corresponding gamer is a registered member, receiving personal information of the corresponding gamer if it is determined that the corresponding gamer is not equal to the registered member, and generating a new ID account; c3) allowing, by the game provision server (GPS), the corresponding member to log in as a member; c4) receiving mobile phone information of a gamer who desires to participate in the game or ID account information of the gamer from the user game console, registering a corresponding mobile phone in combination with a corresponding Web ID, and calling the corresponding mobile phone; and c5) if an authentication password and a response signal for game connection are transmitted to the game provision server (GPS) via the mobile phone, determining, by the game provision server (GPS), whether a current user is a valid member by referring to the corresponding authentication password, and permitting the user to participate in the game if it is determined that the current user is equal to the valid member.

Preferably, the step c) further includes the steps of: c6) receiving, by the game provision server (GPS), gamer's authentication data; c7) determining whether a corresponding gamer is a registered member, receiving personal information of the corresponding gamer if it is determined that the corresponding gamer is not equal to the registered member, and generating a new ID account; c8) allowing, by the game provision server (GPS), the corresponding member to log in as a member; c9) establishing, by the game provision server (GPS), a room for gathering users who desire to participate in the game via the user game console; and c10) installing a program capable of accessing the game provision server (GPS) using the mobile phone, accessing the established room, expressing a participation intention of the game, and approving the game participation by an establishment person of the room.

Preferably, the game-content data is arithmetically processed by the user game console instead of the game provision server (GPS), such that the user game console independently performs the steps of: h) selecting specific game-content data; i) downloading corresponding game content data in the user game console; and j) receiving the key signal generated from the mobile phone via the mobile phone, performing arithmetic processing of the game data, and outputting the arithmetic processing result on the screen.

### ADVANTAGEOUS EFFECTS

The game system for enabling the mobile phone to interact with the user game console according to the present invention can display different information on not only a common screen for all the game participants but also at least one screen for each gamer only, such that a plurality of gamers can participate in the game at the same time on a single screen image, resulting in the implementation of the simultaneous-participation games (e.g., a Korean “Hwatu” card game, a card game, a mah-jong play, and a horse race, etc.).

The user or gamer can effectively conceal his or her unique information from others, resulting in increased interest in the simultaneous-participation-type game. The game system may provide the viewer or user with the high realism using a common screen image in the same manner as in an actual off-line game.

The game system according to the present invention may substitute the mobile phone for the controller (e.g., the mouse or joystick), such that it can provide game operation environments desired by each user. The game system can allow the user or gamer to pay high attention to the common screen, such that it exposes desired advertisement data to several gamers or users located at the same field, resulting in the implementation of increased advertisement effects.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram illustrating a game system for enabling a mobile phone to interact with a user game console according to a first preferred embodiment of the present invention;

FIG. 2 is a block diagram illustrating an interface contained in a game system for enabling a mobile phone to interact with a user game console according to a first preferred embodiment of the present invention;

FIG. 3 is a conceptual diagram illustrating a multi-user multi-game status implemented via a single multi-user game console in a game system for enabling a mobile phone to interact with a user game console according to a first preferred embodiment of the present invention;

FIGS. 4˜5 are flow charts illustrating a method for controlling a game system for enabling a mobile phone to interact with a user game console according to a first preferred embodiment of the present invention; and

FIG. 6 is a flow chart illustrating a method for controlling a single user game console in a game system for enabling a mobile phone to interact with a user game console according to a first preferred embodiment of the present invention.

### BEST MODE FOR CARRYING OUT THE INVENTION

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

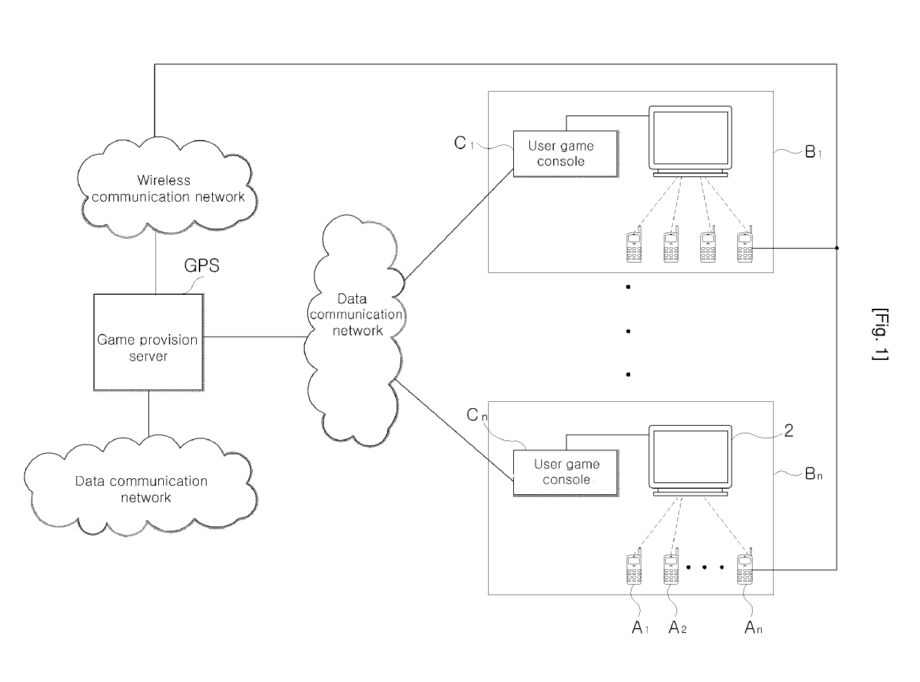

FIG. 1 is a conceptual diagram illustrating a game system for enabling a mobile phone to interact with a user game console according to a first preferred embodiment of the present invention.

Referring to FIG. 1, a game system for enabling a mobile phone and a user game console to interact with a game server according to the present invention enables the user game console to interact with a video display, displays video data generated from the user game console on the video display in order to allow a user or gamer to play a desired game on a large screen, and allows a plurality of gamers to play the game using a single user game console over wireless communication for use of mobile phones.

The above-mentioned game system capable of enabling a mobile phone to interact with the user game console connects the user game console to the video display by wire, transmits a game key signal from users mobile phones to a game provision server (GPS) to process a corresponding game, transmits video- and audio-data generated for the game play time to the video display via a user game console connected to the game provision server (GPS), transmits a key signal received from the mobile phone to the game provision server (GPS), and allows the game provision server (GPS) to perform an arithmetic processing of the received signal, such that the game is executed.

For this purpose, the game system for enabling the mobile phone to interact with the user game console according to the first preferred embodiment of the present invention includes a game provision server (GPS). The game provision server (GPS) transmits a plurality of game contents to a plurality of user game consoles (C1˜Cn), establishes game-participants information received from the user game consoles (C1˜Cn), performs information registration of the game participants, performs a game operation function, performs arithmetic processing of corresponding game contents upon receiving game-execution key signals and gamer information from the user game consoles (C1˜Cn), transmits modified game video- and audio-data to the user game consoles (C1˜Cn), receives a game key signal from the mobile phone of each gamer, and performs arithmetic processing using the received game key signal, thereby con ducting a corresponding game. The game provision server (GPS) receives key signals from the mobile phones (A1˜An) over a mobile communication network.

The game system for enabling the mobile phone to interact with the user game console according to the first preferred embodiment of the present invention includes multi-user game consoles (B1˜Bn). The multi-user game console interfaces with the game provision server (GPS), such that it transmits game authentication information to the game provision server (GPS), transmits a game participation setup signal of each gamer to the game provision server (GPS), receives game video- and audio-data from the game provision server (GPS), outputs the received game video- and audio-data, transmits a game event signal of each gamer to the game provision server (GPS), and controls the game system upon receipt of a game operation value of the game provision server (GPS).

Each of the above-mentioned multi-user game consoles (B1˜Bn) includes user a game console (C1˜Cn), a video display, and mobile phones (A1˜An). The user game console (C1˜Cn) transmits gamer authentication information and a game participation setup signal of each gamer to the game provision server (GPS), receives game images, advertising images, and audio data from the game provision server (GPS), transmits a game event signal of the gamer to the game provision server (GPS), receives a game operation value of the game provision server (GPS), and outputs the received game operation value to the video display. The video display outputs the game images and the audio data received from the user game console (C1˜Cn). Each mobile phone interacts with the user game console (C1˜Cn), and transmits the gamer authentication information, the game participation setup signal of each gamer, and the game key signal for playing a corresponding game to the game provision server (GPS).

In this case, the mobile phones (A1˜An) interact with the user game consoles (C1˜Cn) according to characteristics of game contents, such that they may partially display game data received from the game provision server (GPS) on only the screen of the mobile phones.

If the mobile phones (A1˜An) execute the game in combination with the user game consoles (C1˜Cn), this indicates that the user game consoles (C1˜Cn) gain access to the game provision server (GPS), download game contents from the game provision server (GPS), execute the game, and at the same time can transmit a key signal for executing the corresponding game to the game provision server (GPS) via the mobile phones (A1˜An).

In other words, provided that several users generate key signals via their mobile phones (A1˜An), respectively, and user registration information indicating that corresponding game-content data is executed via a specific user game console (C1˜Cn) is pre-registered in the game provision server (GPS), the game provision server (GPS) can determine which one of the mobile phones (A1˜An) associated with the user game consoles (C1˜Cn) generates the game key signal, such that the game operation can be made available.

Particularly, some parts of game data generated from the game provision server (GPS) may be displayed on only the screen of the mobile phone. For example, during the Go-Stop game, the mobile phone (A1˜An) displays data corresponding to overall cards on the video display, and at the same time displays video data corresponding to cards of each gamer on only the mobile phone (A1˜An). In more detail, according to each gamer's mobile phone number registered in any one of user game consoles (C1˜Cn), video data generated from the game provision server (GPS) is differently transmitted to individual mobile phones (A1˜An) according to individual users, such that different video data is transmitted to the individual mobile phones of the users. As a result, video data corresponding to the cards of each gamer is displayed on only the mobile phone (A1˜An) of each gamer.

The mobile phone (A1˜An) includes a G-sensor (not shown) well known in the art, such that it automatically generates a key signal depending on the location movement of the mobile phone (A1˜An) using the G-sensor. Therefore, the game system according to the present invention replaces a joystick or mouse with the mobile phone (A1˜An), generates a game key signal using the mobile phone (A1˜An), such that the user or gamer can effectively enter desired data in the game system using his or her mobile phone during any activity game (e.g., a multi-user game or sports game).

In other words, the game system according to the present invention transmits key-entry data received via the G-sensor to the game provision server (GPS) over a wireless communication network.

In this case, the G-sensor recognizes the location of each mobile phone (A1˜An), determines whether the location of the mobile phone (A1˜An) is changed to another location, and uses the location variation value of the mobile phone as a game key input value. Since the G-sensor is well known in the art, a detailed description there of will herein be omitted for the convenience of description.

The mobile phone (A1˜An) includes a game-execution algorithm for executing the game. The game-execution algorithm activates the G-sensor. According to the game-execution algorithm, if the key signal is generated from the G-sensor, the user's mobile phone automatically accesses a pre-registered mobile-phone server, and transmits corresponding key data to the mobile-phone server, such that the game-execution algorithm conducts wireless-network connection, and automatically transmits the key data.

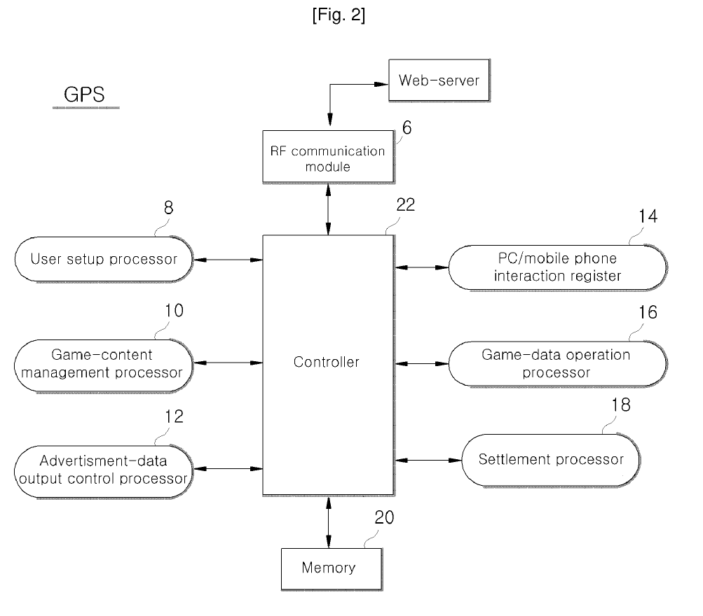

FIG. 2 is a block diagram illustrating an interface contained in a game system for enabling a mobile phone to interact with a user game console according to a first preferred embodiment of the present invention.

Referring to FIG. 2, a game system for enabling a mobile phone to interact with a user game console according to the first preferred embodiment of the present invention includes a wireless communication module, a user setup processor, a game-content management processor, advertisement-data output control processor, a user game console/mobile phone interaction register (denoted by “PC/mobile-phone interaction register), a game data operation processor, a settlement processor, a memory, and a controller.

The wireless communication module denoted by the reference number 6 includes a Web server, a fire wall, a protocol setup processor (not shown). The wireless communication module 6 is connected to a communication network, communicates with the mobile phone (A1˜An) or the user game console (C1˜Cn), receives authentication/user setup signals and key signals associated with various games, and transmits game operation data to the mobile phone (A1˜An) or the user game console (C1˜Cn), resulting in the implementation of data transmission/reception.

The user setup process for establishing participant information of specific game-content data is denoted by the reference number 8. The user setup process 8 receives a request signal for participating in the game from the mobile phone (A1˜An) or the user game console (C1˜Cn), and establishes a corresponding request signal, gamer information, and a mobile phone number.

The game-content management server processor denoted by the reference number 10 processes a variety of game-content data and modification data in association with the user game console (C1˜Cn), and manages the processed resultant data.

The advertisement-data output control processor denoted by the reference number 12 transmits advertisement data to the mobile phone (A1˜An) or the user game console (C1˜Cn) in combination with the output of game data.

The user game console/mobile phone interaction register (PC/mobile phone interaction register) denoted by the reference number 14 registers information of at least one of the mobile phones (A1˜An), capable of conducting the game via any one of user game consoles (C1˜Cn), in combination with a Web ID of a corresponding user, and manages a game key signal and a game operation value according to individual user game consoles and mobile phones.

The game-data operation processor denoted by the reference number 16 processes operation of game data to be transmitted to the user game console (C1˜Cn) by the key data received from the mobile phone (A1˜An).

The settlement processor denoted by the reference number 18 settles the usage fee of the game-contents or item purchase costs by means of the authentication process of the mobile phone (A1˜An) or the user game console (C1˜Cn).

The memory denoted by the reference number 20 includes a RAM and a ROM, and stores game-data processing information, game-participant's information, interaction information between the mobile phone and the user game console, settlement authentication data, and advertisement data, etc.

The controller denoted by the reference number 22 establishes the game-participant setup process in combination with the mobile phone (A1˜An) of the user game console (C1˜Cn), and performs a variety of functions using the operation value of the modified game data, for example, a game output control function, an advertisement-data output control function, a settlement process interface function. In addition, the controller performs operation of game data using key data received from the mobile phone (A1˜An), transmits the game operation value to the user game console (C1˜Cn) using the key data received from the mobile phone (A1˜An), and controls overall operations of the game system.

In the meantime, the game system according to the present invention does not include a mobile phone server in the game provision server (GPS), and can transmit data from the mobile phone (A1˜An) to the game provision server (GPS) over a wired/wireless communication network, instead of a communication network of the mobile phone, using an additional device or a wireless LAN (Local Area Network) communication unit (e.g., a wireless access point (AP) located in the vicinity of the user game console). The additional device is directly connected to the user game console (C1˜Cn), and communicates with the mobile phone via a Bluetooth, a wireless LAN, and an IR (Infrared) communication unit.

Particularly, the wireless LAN communication unit is connected to a superhigh-speed communication network, and is well known to those skilled in the art, such that there is no limitation in constructing the game system of the present invention.

If the key signal generated from the mobile phone (A1˜An) is transmitted to the game provision server (GPS) via the wireless LAN communication unit and the superhigh-speed communication network, the key signal can be more quickly transmitted to the game provision server (GPS), such that a difference in game progress time between the game provision server (GPS) and the mobile phone can be minimized.

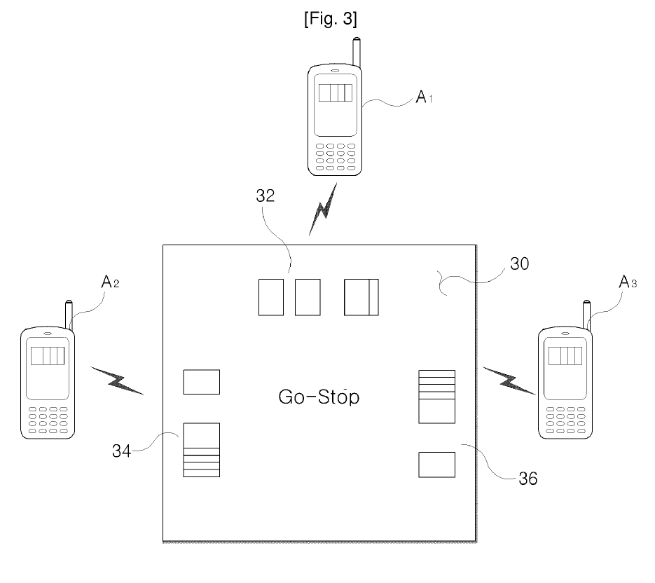

FIG. 3 is a conceptual diagram illustrating a multi-user multi-game status implemented via a single multi-user game console in a game system for enabling a mobile phone to interact with a user game console according to a first preferred embodiment of the present invention.

Referring to FIG. 3, the multi-user multi-game system (e.g., Go-stop game) via a single multi-user game console in the game system for enabling the mobile phone to interact with the user game console according to the first preferred embodiment of the present invention transmits different video- and audio-data to individual mobile phones (A1˜An), and differently transmits corresponding data to the mobile phones (A1˜An).

For example, during the Go-Stop game, the mobile phone (A1˜An) displays data corresponding to overall cards (32, 34, and 36) on the screen 30 of the video display, and at the same time displays video data (e.g., screen information of 1, 2, 3, or 1, 2, 3, 4) corresponding to cards of each gamer on only the mobile phone (A1˜An).

In more detail, according to each gamer's mobile phone number registered in the game provision server (GPS), video/audio data generated from the user game console (C1˜Cn) is differently transmitted to individual mobile phones (A1˜An) over a wireless communication network, such that different video/audio data is transmitted to the individual mobile phones of the users. As a result, video data corresponding to the cards of each gamer is displayed on only the mobile phone (A1˜An) of each gamer.

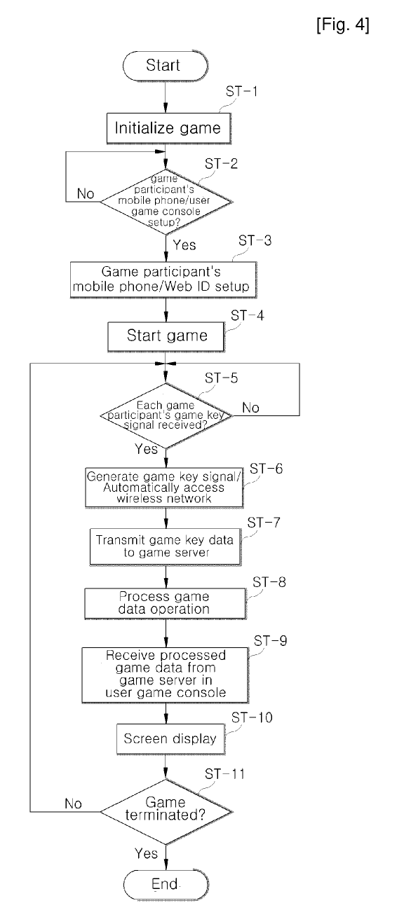

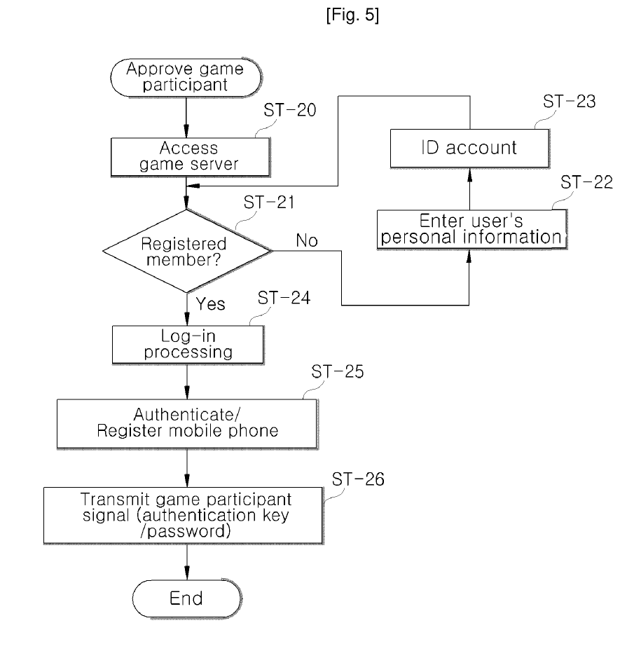

The above-mentioned game system for enabling the mobile phone to interact with the user game console according to the first preferred embodiment of the present invention will hereinafter be described with reference to FIGS. 4-5.

FIG. 4 is a flow chart illustrating a basic game processing function for use in the game system for enabling the mobile phone to interact with the user game console according to the first preferred embodiment of the present invention. FIG. 5 is a flow chart illustrating a game-participant approval processing function of the game participant using the game system for enabling the mobile phone to interact with the user game console according to the first preferred embodiment of the present invention.

Referring to FIG. 4, the game participant transmits a game initialization selection signal using his or her mobile phone (A1˜An), and a plurality of game participants register their mobile phones (A1˜An) in association with any one of the user game consoles (C1˜Cn), such that mobile phone information is registered in association with any one of the user game consoles. In other words, the game participant transmits a corresponding user game console/mobile phone interaction registration information, authentication information, and participant's game start request signal on the condition that he or she has gained access to the game provision server (GPS) using the user game console (C1˜Cn) or the mobile phone (A1˜An).

The game provision server (GPS) receives a corresponding signal, establishes the game participant information and the user game console/mobile phone interaction registration information, transmits corresponding game-content data to the user game console (C1˜Cn), and authenticates the beginning of the game. In other words, the above-mentioned user game console/mobile phone interaction registration information registered in the game provision server (GPS) is a mobile phone number and a Web ID.

Subsequently, the user game console (C1˜Cn) receives corresponding game start information and game-content information, and transmits video- and audio-data of the corresponding game-content data to the video display over a wired/wireless communication network.

Under this condition, if the game participant executes the game-execution algorithm installed in the mobile phone (A1˜An), moves the mobile phone (A1˜An) to another location, and generates a game event signal by pressing a specific key, the game-execution algorithm installed in the mobile phone (A1˜An) controls a corresponding mobile phone to automatically access the game provision server (GPS) of the pre-registered wireless Internet. The mobile phone (A1˜An) transmits a corresponding event signal (i.e., a game key signal) and mobile phone information to the game provision server (GPS).

The game provision server (GPS) receives a corresponding event signal (i.e., the game key signal) and the mobile phone information, extracts user game console information (e.g., Web ID information) associated with the corresponding mobile phone (A1˜An), processes the operation of game data according to the event signal of a corresponding gamer, and transmits modified game data to the corresponding user game console (C1˜Cn) having the Web ID.

The user game console (C1˜Cn) receives corresponding game operation data from the game provision server (GPS), and outputs modified game data to the video display over the Internet.

The game system for enabling the mobile phone to interact with the user game console according to the first preferred embodiment of the present invention can allow a plurality of gamers to enjoy playing the game using a single user game console, allows the user to easily enter a desired key signal according to a wireless key-entry scheme, and can easily establish a plurality of mobile phones as key input tools for the game, such that the user can enjoy playing the game on the large screen of the video display.

The game provision server (GPS) performs gamer authentication as shown in FIG. 4. Referring to FIG. 5, the gamer gains access to the game provision server (GPS) via the mobile phone (A1˜An) or the user game console (C1˜Cn).

The game provision server (GPS) having received gamer authentication data, and determines whether a corresponding gamer is a registered member. If the corresponding gamer is not equal to the registered member, personal information of a corresponding user is received in the game system, and performs the ID account of the user.

Subsequently, the game provision server (GPS) allows a corresponding member to log in as a member of the server. Under this condition, the game provision server (GPS) receives the mobile phone number from the user game console (C1˜Cn), and registers the corresponding mobile phone (A1˜An) corresponding to the received mobile phone number.

In this case, provided that the user game console (C1˜Cn) is authenticated via the mobile phone (A1˜An), and is registered in combination with the mobile phone (A1˜An), the game system transmits a Web ID capable of executing a corresponding game to the game provision server (GPS), and registers the Web ID in combination with the mobile phone (A1˜An) and the user game console (C1˜Cn).

In this case, a communication mode between the game provision server (GPS) and the mobile phone (A1˜An) is generally implemented over a wireless communication network of the mobile phone. If necessary, the game system according to the present invention may use either an additional transmission/reception unit or a wireless LAN communication network such as a LAN. The additional transmission/reception unit is connected to the user game console (C1˜Cn) to facilitate communication to the game provision server (GPS).

Therefore, in the case of performing the authentication process of the above-mentioned mobile phone (A1˜An), all the gamers can allow the mobile phone (A1˜An) to interact with the user game console (C1˜Cn), and can use the interaction result between the mobile phone (A1˜An) and the user game console (C1˜Cn) as a key input unit for conducting the game contents.

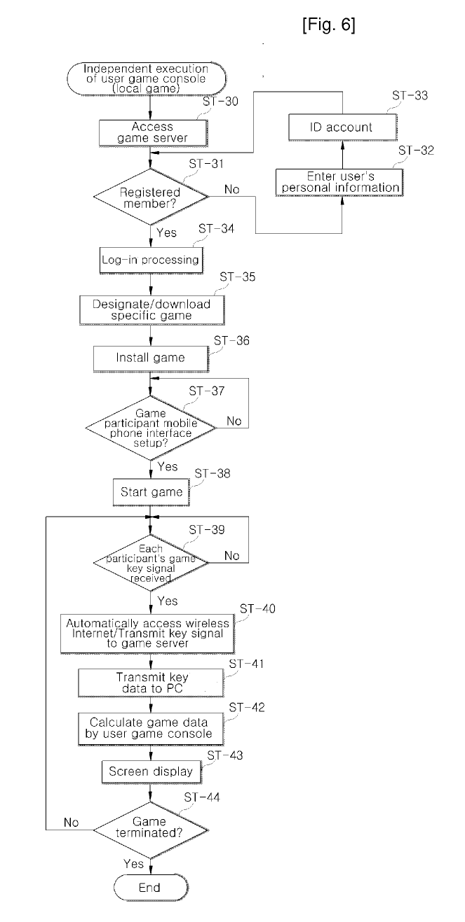

FIG. 6 is a flow chart illustrating a method for controlling a single user game console in a game system for enabling a mobile phone to interact with a user game console according to a first preferred embodiment of the present invention.

Referring to FIG. 6, the game system according to the present invention downloads specific game-content data from among a plurality of game contents uploaded to the game provision server (GPS), conducts a local game using the user game console (C1˜Cn), and allows a plurality of gamers to participate in the local game. The game system shown in FIG. 6 shows a game tool in which the arcade game and a multi-user network game are mixed. By the modification of the game-content data, a plurality of garners can enjoy playing the game using a single user game console.

Firstly, the garner gains access to the game server via the user game console (C1˜Cn).

Under this condition, the game system according to the present invention transmits gamer's authentication data to the game provision server (GPS). The game provision server (GPS) determines whether a corresponding garner is a registered member or not. If it is determined that the corresponding garner is not equal to the registered member, the game system receives personal information of the corresponding user, and performs the ID account. In this case, in order to infinitely enjoy playing the payfor-use game contents, the game system may invite the user to register as a valid member in the game provision server (GPS).

Subsequently, the game provision server (GPS) invites the corresponding member to log in as a member. Under this condition, if the game provision server (GPS) receives a specific game-content selection signal from the mobile phone (A1˜An) or the user game console (C1˜Cn), authenticates the received signal, the game provision server (GPS) downloads the corresponding game-content data in the user game console (C1˜Cn) of the corresponding user.

The downloaded game-content data is installed in the user game console (C1˜Cn). The user game console (C1˜Cn) transmits mobile phone information (i.e., a mobile phone number+game ID information) of at least one game participant to the game provision server (GPS).

The game provision server (GPS) registers several mobile phones (A1˜An) in combination with a single game ID. If the game begins, the game provision server (GPS) processes the game data via the game-content data installed in the user game console (C1˜Cn), and displays the processed video- and audio-data on the video display.

Under this condition, if the game generates the game event signal by moving the mobile phone (A1˜An) to another location or pressing a specific key, a game-execution processor of the mobile phone (A1˜An) is automatically connected to the Internet, and the mobile phone (A1˜An) transmits corresponding key input data to the game provision server (GPS).

The game provision server (GPS) receives the key input data of the mobile phone (A1˜An), transmits key input data and the key input data to the user game console (C1˜Cn) over a network. The user game console (C1˜Cn) processes the operation of the corresponding game data.

In this case, although a plurality of garners participate in the game executed in the single user game console (C1˜Cn) using several mobile phones (A1˜An), mobile phone information and the key input data are transmitted to the game provision server (GPS), and are then re-transmitted to the user game console (C1˜Cn), such that the game-content data can recognize which one of characters is associated with the key input data.

Therefore, the user game console (C1˜Cn) displays the modified game data on the video display. Also, the user game console (C1˜Cn) determines whether a game is terminated or not, such that it finishes playing the game according to the determined result.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

### INDUSTRIAL APPLICABILITY

As apparent from the above description, the game system for enabling the mobile phone to interact with the user game console according to the present invention can display different information on not only a common screen for all the game participants but also at least one screen for each gamer only, such that a plurality of gamers can participate in the game at the same time on a single screen image, resulting in the implementation of the simultaneous-participation games (e.g., a Korean “Hwatu” card game, a card game, a mah-jong play, and a horse race, etc.).

The user or gamer can effectively conceal his or her unique information from others, resulting in increased interest in the simultaneous-participation-type game. The game system may provide the viewer or user with the high realism using a common screen image in the same manner as in an actual off-line game.

The game system according to the present invention may substitute the mobile phone for the controller (e.g., the mouse or joystick), such that it can provide game operation environments desired by each user. The game system can allow the user or gamer to pay high attention to the common screen, such that it exposes desired advertisement data to several gamers or users located at the same field, resulting in the implementation of increased advertisement effects.

1. A game system for enabling a mobile phone to interact with a user game console comprising:
a game provision server (GPS) for transmitting a plurality of game contents to a plurality of user game consoles (C1˜Cn), establishing game-participants information received from the user game consoles (C1˜Cn), and performs information registration of the game participants, performs a game operation function, performing arithmetic processing of corresponding game contents upon receiving game-execution key signals and gamer information from the user game consoles (C1˜Cn), transmitting modified game video- and audio-data to the user game consoles (C1˜Cn), receiving a game key signal from the mobile phone of each gamer, and performing arithmetic processing using the received game key signal, thereby conducting a corresponding game; and
multi-user game consoles (B1˜Bn), each of which interfaces with the game provision server (GPS), transmits game authentication information to the game provision server (GPS), transmits a game participation setup signal of each gamer to the game provision server (GPS), receives game video- and audio-data from the game provision server (GPS), outputs the received game video- and audio-data, transmits a game event signal of each gamer to the game provision server (GPS), and controls the game system upon receipt of a game operation value of the game provision server (GPS).

2. The game system according to claim 1, wherein each of the multi-user game consoles (B1˜Bn) includes:
a user game console for transmitting gamer authentication information and a game participation setup signal of each gamer to the game provision server (GPS), receiving game images, advertising images, and audio data from the game provision server (GPS), transmitting a game event signal of the gamer to the game provision server (GPS), receiving a game operation value of the game provision server (GPS), and outputting the received game operation value to a video display;
a video display for outputting the game images and the audio data received from the user game console; and
at least one mobile phones for interacting with the user game console, and transmitting the gamer authentication information, the game participation setup signal of each gamer, and the game key signal for playing a corresponding game to the game provision server (GPS).

3. The game system according to claim 2, wherein the mobile phone interact with the user game console according to characteristics of game contents, such that it partially displays game data received from the game provision server (GPS) on only the screen of the mobile phone.

4. The game system according to claim 2, wherein the mobile phone includes:
a G-sensor for automatically generating a key signal equal to a key input signal according to the movement of the mobile phone, whereby
input data is automatically transmitted to the game provision server (GPS) over a wireless communication network for the mobile phone.

5. The game system according to claim 2, wherein the mobile phone includes a game-execution algorithm for executing the game, such that the game-execution algorithm enables the mobile phone to recognize the occurrence of key data in the case of the game execution, enables the mobile phone to automatically access a communication network, and enables the mobile phone to automatically transmit the key data to the game provision server (GPS) pre-registered.

6. The game system according to claim 4, wherein the mobile phone includes:
a transmission/reception unit for enabling the mobile phone to communicate with the user game console via a Bluetooth, IR (Infrared) communication, or other RF (Radio Frequency) data communication, such that the game data is transmitted to the game provision server (GPS) over the Internet.

7. The game system according to claim 2, wherein the game provision server (GPS) includes:
a wireless communication module which includes a Web server, a fire wall, a protocol setup processor, communicates with the mobile phone or the user game console, receives authentication/user setup signals and key signals associated with various games, and transmits game operation data to the mobile phone or the user game console, resulting in the implementation of data transmission/reception;
a user setup processor which receives a request signal for participating in the game from the mobile phone or the user game console, and establishes a corresponding request signal, gamer information, and a mobile phone number;
a game-content management processor which processes a variety of game-content data and modification data in association with the user game console (C1˜Cn), and manages the processed resultant data;
advertisement-data output control processor which transmits advertisement data to the mobile phone or the user game console in combination with the output of game data;
a user game console/mobile phone interaction register which registers information of at least one of the mobile phones, capable of conducting the game via any one of user game consoles (C1˜Cn), in combination with a Web ID of a corresponding user, and manages a game key signal and a game operation value according to each user game console and each mobile phone;
a game data operation processor which processes operation of game data to be transmitted to the user game console by the key data received from the mobile phone;
a settlement processor which settles a usage fee of the game-contents or item purchase costs by means of the authentication process of the mobile phone or the user game console;
a memory which includes a RAM and ROM, and stores data-data processing information, game-participant's information, interaction information between the mobile phone and the user game console, settlement authentication data, and advertisement data; and
a controller which establishes the game-participant setup process in combination with the mobile phone of the user game console, and performs a game output control function, an advertisement-data output control function, a settlement process interface function using the operation value of the modified game data, performs operation of game data using key data received from the mobile phone, transmits the game operation value to the user game console using the key data received from the mobile phone, and controls overall operations of the game system.

8. A game method for enabling a mobile phone to interact with a user game console comprising the steps of:
a) receiving, by a game provision server (GPS), a game initialization selection signal from a user game console;
b) transmitting, by the user game console, mobile phone information, Web ID information, authentication information, a participant's game start request signal to the game provision server (GPS);
c) receiving, by the game provision server (GPS), a corresponding signal, registering the Web ID information in combination with the mobile phone, transmitting corresponding game-content data to the user game console, and authenticating the beginning of a game;
d) receiving, by the user game console, the corresponding game-content start information and game-content information, and outputting the received information to a video display;
e) if the game participant moves the mobile phone to another location, or generates a game event signal by pressing a specific key, transmitting the corresponding event signal to the game provision server (GPS) via a mobile-phone transmission/reception unit connected to either a mobile-phone communication network or the user game console;
f) performing arithmetic processing of game data according to the event signal of a corresponding gamer, and transmitting modified game data to the corresponding user game console and the mobile phone; and
g) displaying the modified game data on the screen of the video display.

9. The game method according to claim 8, wherein the step c) includes the steps of:
c1) receiving, by the game provision server (GPS), gamer's authentication data;
c2) determining whether a corresponding gamer is a registered member, receiving personal information of the corresponding gamer if it is determined that the corresponding gamer is not equal to the registered member, and generating a new ID account;
c3) allowing, by the game provision server (GPS), the corresponding member to log in as a member;
c4) receiving mobile phone information of a gamer who desires to participate in the game or ID account information of the gamer from the user game console, registering a corresponding mobile phone in combination with a corresponding Web ID, and calling the corresponding mobile phone; and
c5) if an authentication password and a response signal for game connection are transmitted to the game provision server (GPS) via the mobile phone, determining, by the game provision server (GPS), whether a current user is a valid member by referring to the corresponding authentication password, and permitting the user to participate in the game if it is determined that the current user is equal to the valid member.

10. The game method according to claim 8, wherein the step c) further includes the steps of:
c6) receiving, by the game provision server (GPS), gamer's authentication data;
c7) determining whether a corresponding gamer is a registered member, receiving personal information of the corresponding gamer if it is determined that the corresponding gamer is not equal to the registered member, and generating a new ID account;
c8) allowing, by the game provision server (GPS), the corresponding member to log in as a member;
c9) establishing, by the game provision server (GPS), a room for gathering users who desire to participate in the game via the user game console; and
c10) installing a program capable of accessing the game provision server (GPS) using the mobile phone, accessing the established room, expressing a participation intention of the game, and approving the game participation by an establishment person of the room.

11. The game method according to claim 8, wherein the game-content data is arithmetically processed by the user game console instead of the game provision server (GPS), such that the user game console independently performs the steps of:
h) selecting specific game-content data;
i) downloading corresponding game content data in the user game console; and
j) receiving the key signal generated from the mobile phone via the mobile phone, performing arithmetic processing of the game data, and outputting the arithmetic processing result on the screen.
